(19) United States
(12) Patent Application Publication
(10) Pub. No.: US 2025/0353683 A1
(43) Pub. Date: Nov. 20, 2025

(54) Automated Cup Dispenser

(71) Applicant: Kluck, LLC, Tampa, FL (US)

(72) Inventors: Mark Levey, Tampa, FL (US); Natalia Levey, Tampa, FL (US); Varshanth Vemugunta, Tampa, FL (US)

(21) Appl. No.: 19/203,745

(22) Filed: May 9, 2025

Related U.S. Application Data
(60) Provisional application No. 63/648,525, filed on May 16, 2024.

(51) Int. Cl. B65G 1/137; G06K 7/14; G07G 1/12

(52) U.S. Cl. CPC B65G 1/1371; B65G 2203/044; G06K 7/1413; G06K 7/1417; G07G 1/12

(57) ABSTRACT

An automated cup dispenser with a dispenser body having an internal passageway dimensioned to hold a stack of cups and an electronically-controlled cup dispenser configured to selectively release a bottom cup from the stack of cups. The automated cup dispenser includes circuitry configured to: receive a command indicative of one or more cups to be dispensed; and activate the electronically-controlled cup dispenser in response to receiving the command to dispense one or more cups based on the command.

### RELATED APPLICATIONS

This application claims the benefit of U.S. Provisional Application No. 63/648,525 filed May 16, 2024 for an “Automated Cup Dispenser,” which is hereby incorporated by reference in its entirety.

### BACKGROUND

There are many establishments, such as quick dining restaurants and movie theaters, where merchants provide cups for customers to use at self-serve drink machines. For in-person transactions, merchants typically provide cups at a point of sale (“POS”) device by having a cashier or other employee manually pull the cup(s) corresponding to each order. Unfortunately, manually doling out cups at the POS device takes time and slows down order processing, which increases wait time for customers. With online orders, merchants also manually pull cups corresponding to orders, which is time consuming. Another downside is that the employees are handling all of the cups, which reduces sanitation. Moreover, there is a potential security risk because it can be difficult to monitor whether cups are being given out without paying, which could lead to revenue loss.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for dispensing cups;

FIG. 2 is a simplified block diagram of at least one embodiment of an automated cup dispenser of FIG. 1;

FIG. 3 is a perspective view of an example automated cup dispenser according to an embodiment of this disclosure;

FIG. 4 is an exploded view of the example automated cup dispenser shown in FIG. 3;

FIG. 5 is a front perspective view of the base structure of the example automated cup dispenser shown in FIG. 3;

FIG. 6 is a rear perspective view of the base structure of the example automated cup dispenser shown in FIG. 3;

FIG. 7 is a front view of the base structure of the example automated cup dispenser shown in FIG. 3;

FIG. 8 is a rear view of the base structure of the example automated cup dispenser shown in FIG. 3;

FIG. 9 is a front perspective view of the first level structure of the example automated cup dispenser shown in FIG. 3;

FIG. 10 is a rear perspective view of the first level structure of the example automated cup dispenser shown in FIG. 3;

FIG. 11 is a front view of the first level structure of the example automated cup dispenser shown in FIG. 3;

FIG. 12 is a rear view of the first level structure of the example automated cup dispenser shown in FIG. 3;

FIG. 13 is a front perspective view of the second level structure of the example automated cup dispenser shown in FIG. 3;

FIG. 14 is a rear perspective view of the second level structure of the example automated cup dispenser shown in FIG. 3;

FIG. 15 is a front view of the second level structure of the example automated cup dispenser shown in FIG. 3;

FIG. 16 is a rear view of the second level structure of the example automated cup dispenser shown in FIG. 3;

FIG. 17 is a front perspective view of the top structure of the example automated cup dispenser shown in FIG. 3;

FIG. 18 is a rear perspective view of the top structure of the example automated cup dispenser shown in FIG. 3;

FIG. 19 is a front view of the top structure of the example automated cup dispenser shown in FIG. 3;

FIG. 20 is a rear view of the top structure of the example automated cup dispenser shown in FIG. 3;

FIGS. 21-26 are simplified block diagrams of at least one embodiment of a method for dispensing cups that may be executed by the automated cup dispenser of FIG. 1; and

FIGS. 27 and 28 are perspective views of example cup holding assemblies for holding three stacks and four stacks of cups to be dispensed, respectively, that could be internal to the automated cup dispenser shown in FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In some embodiments, this disclosure provides an automated cup dispenser. In some cases, the automated cup design is particularly suited for restaurants (and other merchants that use self-serve drink dispensers). For example, embodiments of the automated cup dispenser could streamline these merchant's beverage service and prevent revenue loss from unpaid drink orders. In some aspects, the automated cup dispenser may reduce labor, make purchases happen more quickly, is sanitary and secure.

Depending on the circumstances, the automated cup dispenser could dispense cups in a variety of ways. Consider an example at a quick service restaurant in which the automated cup dispenser provides the ability to charge for the cup (and the drink) when the cup is dispensed to the guest. In this example, a guest could be at the counter and place their order with a drink. The guest pays the counter person, and the automated cup dispenser dispenses the cup (or cups) to the guest immediately, while the counter person is taking the next order. The guest can go directly to the fountain (i.e., self-service drink dispenser) for their drink(s). Consider another example in which one or more kiosks are placed around the establishment, and the automated cup dispenser could be placed next to the kiosks (or be integrated into the kiosks). The guest places their order and pays at the kiosk and the automated cup dispenser would dispenses the cup instantly at the kiosk in response to the payment.

In another example, the automatic cup dispenser could dispense cups based on scanning a QR code or barcode. For example, a QR code could be printed on the receipt at a kiosk or at the counter register upon payment. The guest scans the barcoded receipt on the automatic cup dispenser's image capture device, and the cup is dispensed. In some cases, the guest is issued a QR code on a mobile app upon payment. The guest displays their phone QR Code to the image capture device on the automated cup dispenser, and a cup is dispensed.

In some embodiments, the automatic cup dispenser has two modes: a user mode and a manager mode. In the user mode, the dispenser is totally secure and will dispense cups as described herein. In the manager or service mode, a manager can place the dispenser into manager mode by scanning an individual manager QR code from their phone at the dispenser's image capture device. This manager code could be defined in an online portal associated with the POS system. This way each establishment can have personalized manager codes. Once in manager mode, a different menu display comes up on the dispenser. From this menu the manager can choose various options, such as:
1. Dispense a cup to a guest at no charge.
2. Unlock and open the dispenser.
3. Take the dispenser out of service
4. Reload cups into the dispenser
5. Reset the cup quantity in the dispenser

In some illustrative embodiments, the dispenser could be integrated into a POS platform. In some cases, the dispenser could operate in conjunction with other POS systems using an open API. In some cases, the dispenser includes cloud-based technology and runs on WIFI. Typically, the dispenser has an adjustable cup size to dispense a variety of difference cup sizes. The dispenser is secure by only allowing the quantity of cups to be dispensed that were placed and paid for with an order, and prevents cups from being touched until they are dispensed. For example, a QR code cannot be reused from a mobile app barcode or a receipt once the total order quantity of cups has been dispensed. In some cases, this dispenser provides system notifications and reports to managers. For example, the reports could include one or more of the following:
a. Please reload the dispenser, available cups have reached a preset minimum quantity.
b. Alert if the dispenser is empty.
c. Alert if the dispenser stops working for any reason (AC power failure, cup jam, the dispenser goes into manager mode).
d. Records who, when and how long the dispenser is in manager mode.
e. Records down time for any reason
f. Records no-sale cups dispensed by manager.

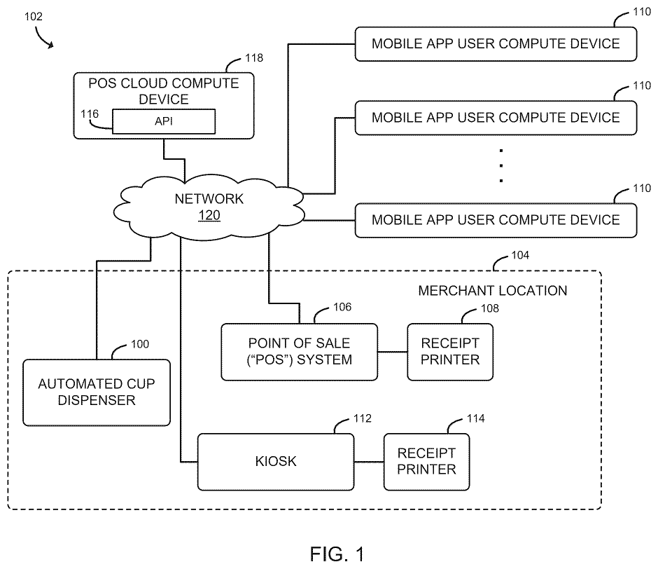

Referring now to FIG. 1, an automated cup dispenser 100 is shown in the illustrative environment 102 in which it may operate at a merchant location 104 (e.g., a restaurant, movie theater, convenience store, etc.). Although a single automated cup dispenser 100 is shown for purposes of simplicity, multiple automated cup dispensers could be provided in a merchant location 104 depending on the circumstances. As shown, the illustrative environment 102 includes a point of sale (“POS”) system 106 through which orders may be processed; as shown, the POS system 106 includes a receipt printer 108, such as for printing receipts regarding orders for which cups need dispensed. Depending on the circumstances, the POS system 106 could be a cloud-based POS platform, such as the Kluck™ restaurant management system offered by Kluck, LLC of Tampa, Florida. For example, the POS system 106 may include one or more computer devices at the merchant location 104 for in-person ordering of, among other things, drinks or other products to be dispensed in cups. In some cases, the POS system 106 may provide online ordering from which orders can be made with one or more mobile computer devices 110, such as orders for which cups need to be dispensed from the automated cup dispenser 100. In the environment 102 shown, there is also a kiosk 112 from which orders can be made at the merchant location 104. As shown, there is a receipt printer 114 for printing receipts of orders on the kiosk 112 can that be used to dispense cups from the automated cup dispenser 100. In some embodiments, the automated cup dispenser 100 may be integrated into the POS system 106 such that the automated cup dispenser 100 can be activated/controlled through commands made by the POS system 106. Depending on the circumstances, in some embodiments, instead of integrating the automated cup dispenser 100 into the POS system 106, the automated cup dispenser 100 could be selectively activated based on calls to an API 116 executing on a cloud-based compute device 118.

In the environment 102 shown, the automated cup dispenser 100 may be controlled directly from the POS system 106. For example, when an order is made in-person on the POS system 106 for an item that is dispensed into a cup, the POS system 106 could send a command to the automatic cup dispenser 100 to dispense a number of cups corresponding to the order. Although the POS system 106 is shown at the merchant location 104 for purposes of simplicity, it should be understood that in some cases at least a portion of the POS system 106 could be in the cloud, and the command could be made to the automated cup dispenser 100 via a network 120, such as the Internet. For example, there could be a gateway (not shown) at the merchant location 104 to facilitate communications between the automated cup dispenser 100 and the POS system 106 over the network 120. In some cases, the automated cup dispenser 100 may be controlled from the kiosk 112. For example, an order for an item to be dispensed into a cup could be entered into the kiosk 112, and the kiosk 112 could send a command to the automated cup dispenser 100. In some cases, the POS system 106 and/or the kiosk 112 could print a receipt with an order code, such as a QR code and/or a barcode, which could be scanned by the automated cup dispenser 100 to dispense cup(s). In some circumstances, users making an online order could be issued a QR code and/or a barcode that could be scanned by the automated cup dispenser 100 to dispense cup(s). In some embodiments, a third party POS system could dispense cup(s) by sending commands to the automated cup dispenser 100 via the API 116.

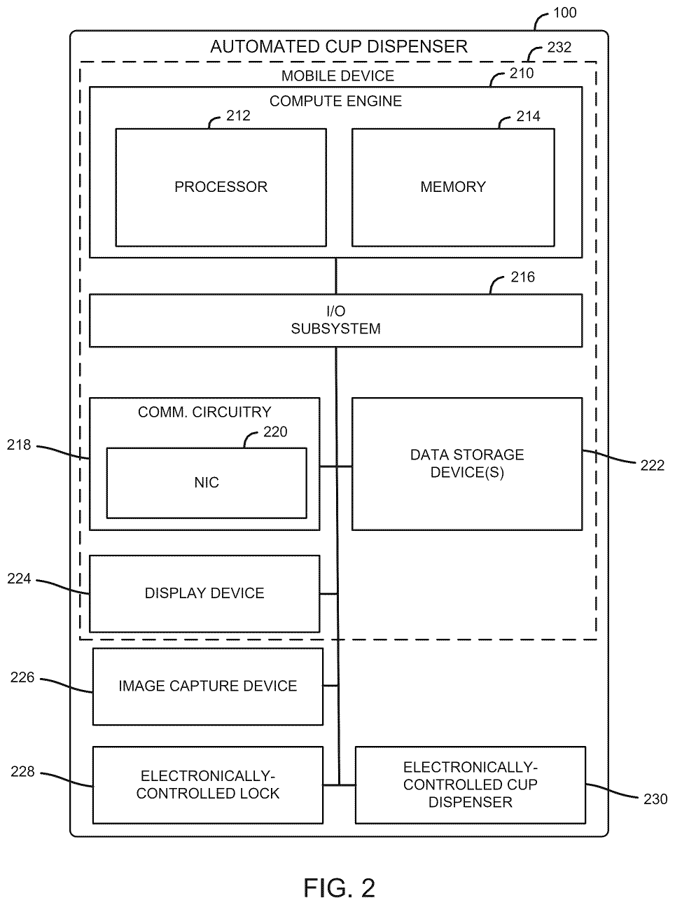

Referring now to FIG. 2, the illustrative automated cup dispenser 100 includes a compute engine 210, an input/output (I/O) subsystem 216, communication circuitry 218, and one or more data storage devices 222. In some embodiments, the automated cup dispenser 100 may include one or more display devices 224, an image capture device 226 (e.g., barcode scanner, camera, etc.), an electronically-controlled lock 228, and an electronically-controlled cup dispenser 230. In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (A SIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the automated cup dispenser 100 to perform one or more operations described herein. In embodiments, the processor 212 is further capable of receiving, e.g., from the memory 214 or via the I/O subsystem 216, one or more signals from external sources or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as transaction identifiers, applications, libraries, and drivers.

The compute engine 210 is communicatively coupled to other components of the automated cup dispenser 100 via the I/O subsystem 216, which may be embodied as circuitry and/or components to facilitate input/output operations with the compute engine 210 (e.g., with the processor 212 and the main memory 214) and other components of the automated cup dispenser 100. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the automated cup dispenser 100, into the compute engine 210.

The communication circuitry 218 may be embodied as any communication circuit, device, or collection thereof, capable of enabling communications over a network between the automated cup dispenser 100 and another device (e.g., POS system 106, kiosk 112, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the automated cup dispenser 100 to connect with another compute device (e.g., POS system 106, kiosk 112, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the automated cup dispenser 100 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the automated cup dispenser 100, POS system 106, and/or kiosk 112, may be in communication via a network 120, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

In some embodiments, at least a portion of the automated cup dispenser 100 could be formed from an existing mobile device 232, such as a tablet computer or mobile phone that is loaded with POS system software. In the example shown, the compute engine 210, I/O system 216, communication circuitry 218, data storage device(s) 222, and display device 224 could be formed from the mobile device 232. Depending on the circumstances, the mobile device 210 could include an image capture device 226, such as a camera for scanning a barcode and/or QR code.

The electronically-controlled lock 228 may be embodied as an electromagnetic lock. By way of example, controlling locking/unlocking of the electromagnetic lock could be done with one or more relays. In some cases, the electronically-controlled lock 228 could be used to control access to the plurality of cups stored in the automated cup dispenser 100. For example, the electronically-controlled lock 228 could prevent opening of an access door in a locked position, and the electronically-controlled lock could be unlocked to provide access to reload the automatic cup dispenser 100 with cups and/or otherwise service the dispenser 100.

The electronically-controlled cup dispenser 230 may be embodied as an automatic plastic or paper cup dispenser. By way of example only, the electronically-controlled cup dispenser 230 could be embodied as a product offered by Dispensing Components Inc. of West Des Moines, Iowa under the name Series 674 Adjustable Automatic Cup Dispenser. In some cases, the electronically-controlled cup dispenser 230 is configured to dispense a single cup each time it is activated.

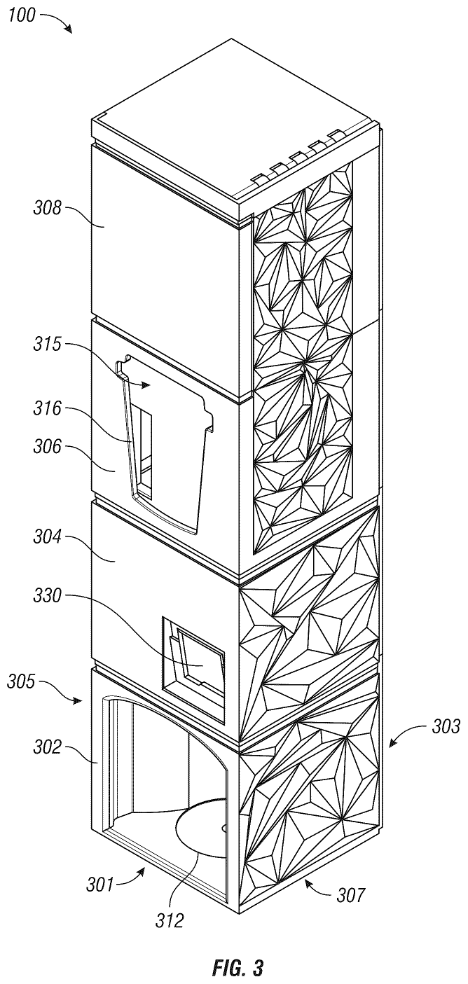

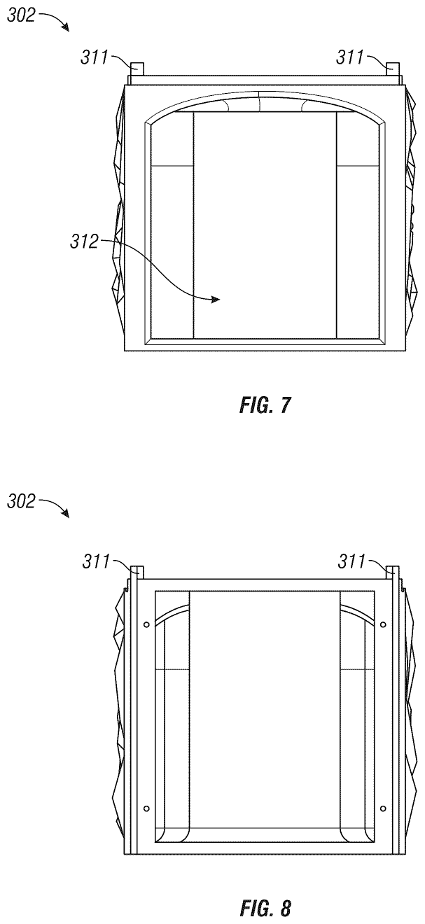

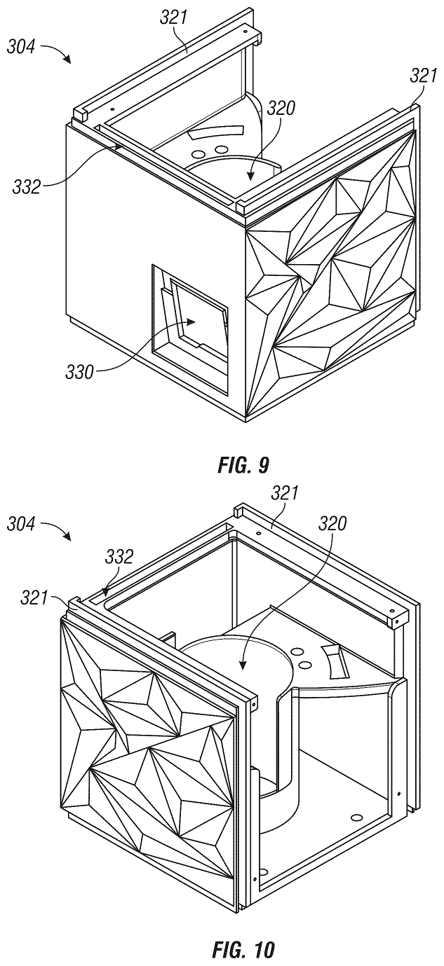

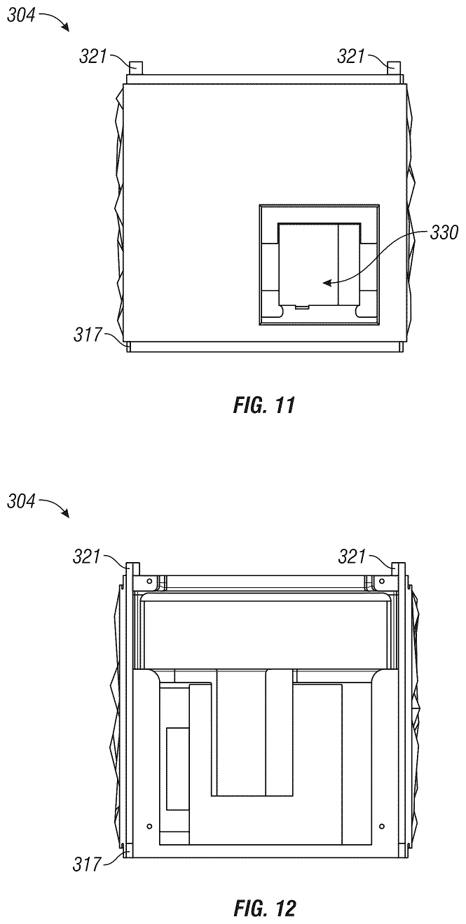

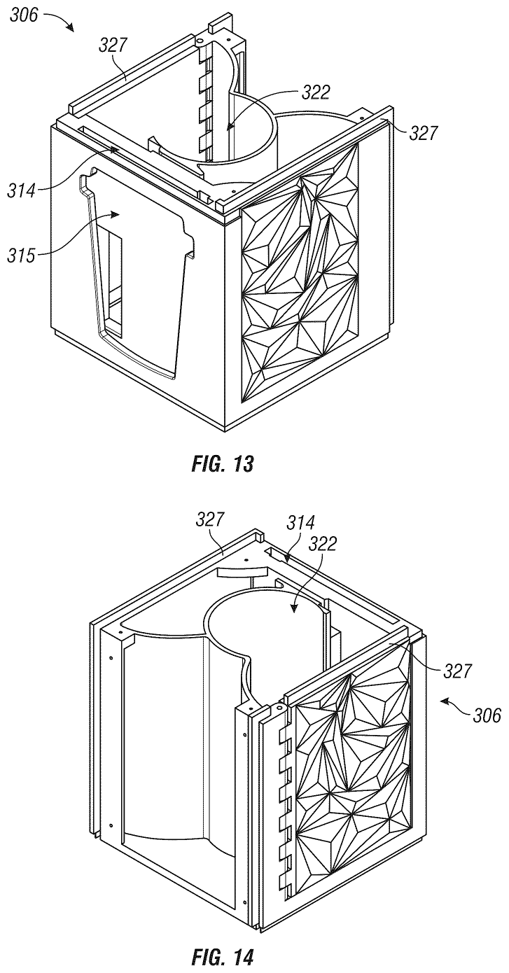

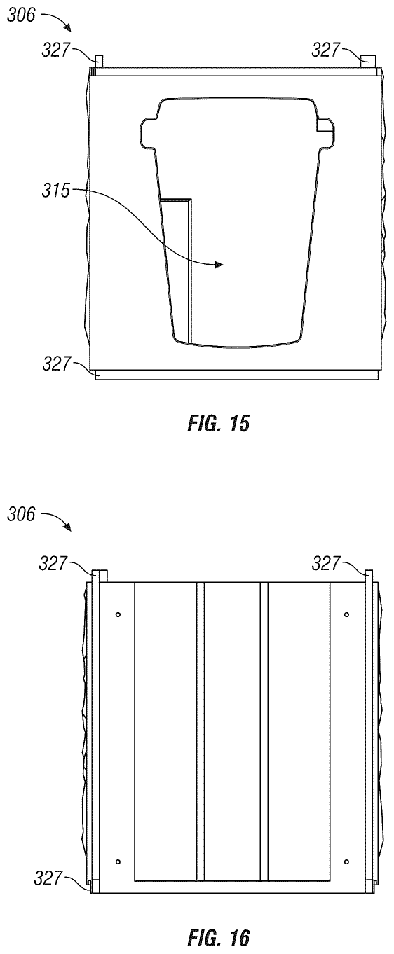

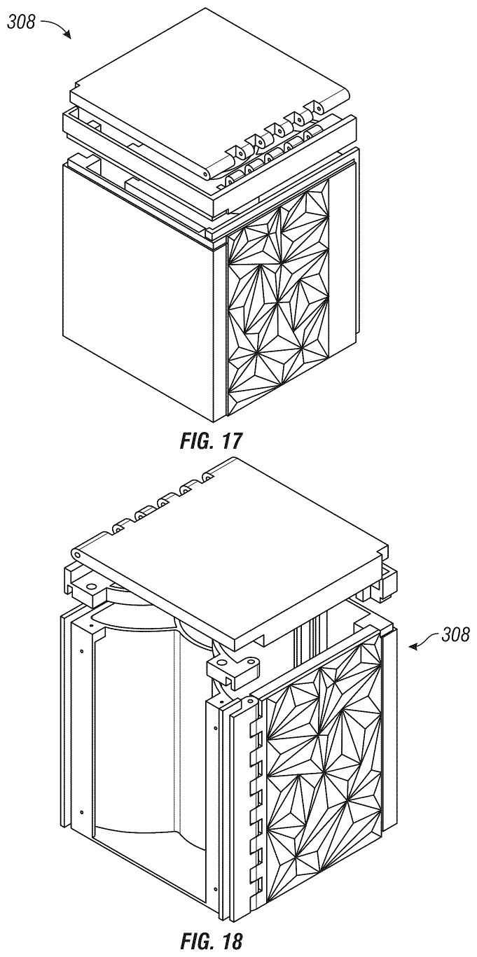

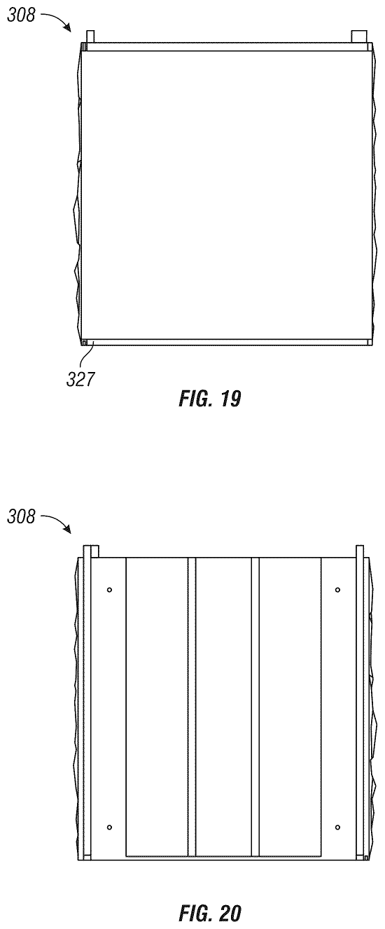

Referring now to FIGS. 3-20, there is shown an embodiment of the automated cup dispenser 100. As shown, the automated cup dispenser 100 includes a front 301, a back 303, a first side 305, and a second side 307. In the embodiment shown, the automated cup dispenser 100 includes a base structure 302, a first level structure 304 stacked on the base structure 302, a second level structure 306 stacked on the first level structure 304, and a top level structure 308 stacked on the second level structure 306. As shown, each of the structures 302, 304, 306, 308 have an approximately cube-like structure that are stacked on top of each other. However, the structures 302, 304, 306, 308 of the automated cup dispenser 100 could be embodied in a variety of shapes and sizes depending on the circumstances. Although four structures 302, 304, 306, 308 are shown for purposes of example, there could be more or less structures depending on the circumstances.

In the embodiment shown, the top side 313 of the base structure 302 includes one or more flanges 311 that are received by collar 317 formed in a bottom side of the first level structure 304. As shown, the top side 319 of the first level structure 304 includes one or more flanges 321 that are received by collar 323 formed in a bottom side of the second level structure 306. In this embodiment, the top side 325 of the second level structure 306 includes one or more flanges 327 that are received by collar 329 formed in a bottom side of the top level structure 308. Depending on the circumstances, the structures 302, 304, 306, 308 could be fastened together with one or more fasteners, adhesive, welding, etc. The structures 302, 304, 306, 308 could be formed from a variety of rigid materials, such as plastic, metal, wood, etc. Although the embodiment shown is modular, embodiments are contemplated in which the automated cup dispenser 300 is formed as an integral structure.

During use, when the automated cup dispenser 100 activates the electronically-controlled cup dispenser 230 to dispense a cup, the cup will drop into a rubber gasket to slow the cup down. The customer can retrieve the dispensed cup from the cup retrieving area 312 and use a self-serve drink dispenser at the merchant location 104 to fill the cup. As discussed herein, there are multiple ways in which the automated cup dispenser 100 may activate the electronically-controlled cup dispenser 230. For example, the automated cup dispenser 100 may receive a command from the POS system 106 and/or kiosk 112, which causes activation of the electronically-controlled cup dispenser 230 to dispense a cup into the cup retrieving area 312.

In some cases, the automated cup dispenser 100 could activate the electronically-controlled cup dispenser 230 based on scanning a receipt and/or a mobile device, such as for a QR code or a barcode. In the embodiment shown, the first level structure 304 includes a window 330 through which an image capture device 226 (not shown) may scan an order code, such as a QR code or barcode. For example, a customer could hold up their receipt and/or mobile device screen up to the image capture device 226 to initiate dispensing of cup(s) corresponding to their order.

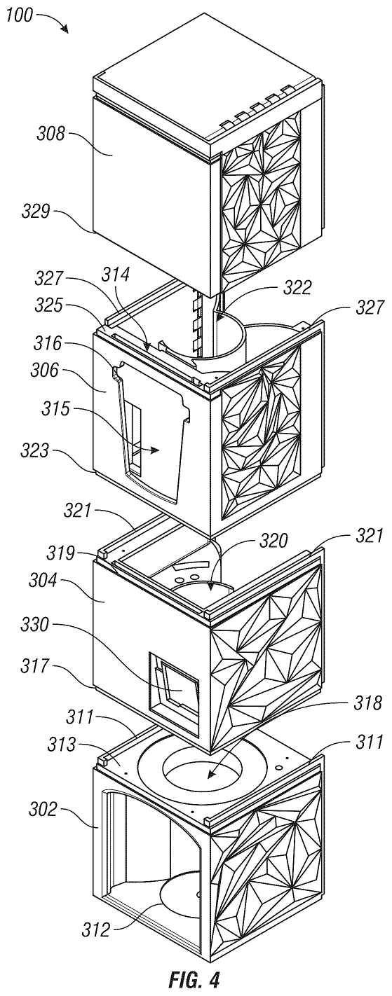

As discussed herein, the automated cup dispenser 100 may be embodied, as least in part, by a mobile device 232, such as a tablet computer. In the embodiment shown, as best seen in FIGS. 4, 13, and 14, the second level structure 306 includes a slot 314 through which a mobile device 232 can be inserted into a pocket 315 dimensioned to receive the mobile device 232. In the embodiment shown, there is a cut-out portion 316 in a front wall of the second level structure 304 to expose at least a portion of the display 224 of the mobile device 232 when it is inserted into the pocket 315. In some cases, the first level structure 304 includes a pocket 332 (see FIGS. 4, 9, and 10) for receiving a portion of the mobile device 232. For example, the display 224 could be embodied as a touch-screen on the mobile device 232 and the user could interact with a user interface on the display 224 to perform various functions of the automated cup dispenser 100. As shown, there is a cut-out portion 316 is shaped to resemble a cup.

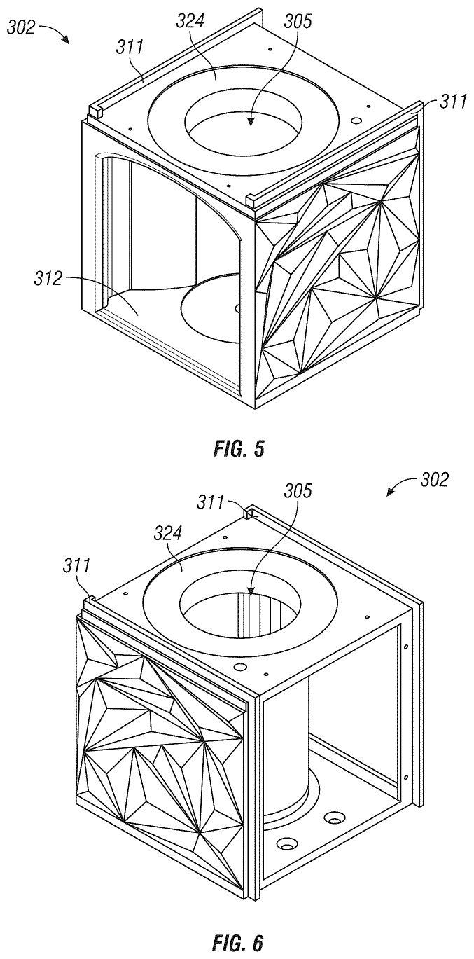

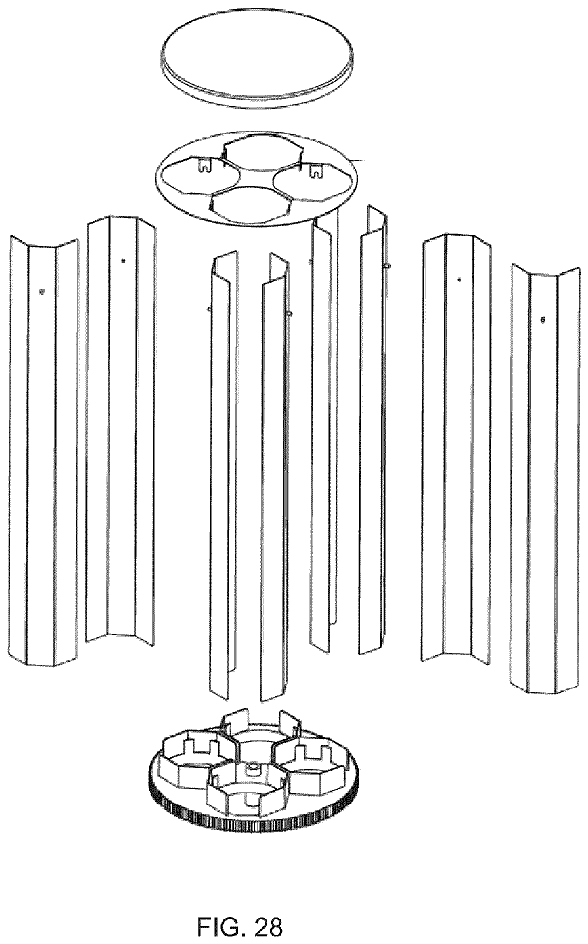

As best seen in FIG. 4, there is a vertical, internal passageway formed in the automated cup dispenser 100 that is dimensioned to hold a stack of cups to be dispensed. In some cases, the automated cup dispenser 100 could hold two, three (see FIG. 27), four (see FIG. 28) or more stacks of cups, each of which could be dispensed as discussed herein. For example, for embodiments in which two or more stacks of cups are held within the internal passageway, the stacks could be configured to rotate about a longitudinal axis to be aligned with the cup retrieving area 312. By way of example only, an embodiment with three stacks of 90 cups could be dispensed stack-by-stack in which one of the stacks is aligned with the cup retrieving area 312 until fully dispensed, and then rotated about a longitudinal axis until another stack of cups is aligned with the cup retrieving area 312 and dispensed, and so forth. In the example shown, the base structure 302 has a base opening 318, the first level structure 304 has a first opening 320, and second level structure 306 has a second opening 322. Each of these openings 318, 320, 322 are aligned with each other to form the passageway for holding a stack of cups to be dispensed. By way of example only, when the electronically-controlled dispenser is activated, this could cause the bottom cup (i.e., the cup closest to the cup retrieving area 312) in the stack of cups to drop from the first level structure 304 and fall via gravity into the cup retrieving area 312 of the base structure 302. In some embodiments, the top 313 of the base structure 302 may include a recessed portion 324 (see FIGS. 5-6) to receive at least a portion of the electronically-controlled cup dispenser 230.

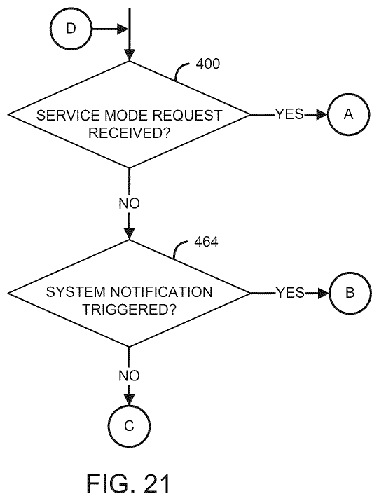

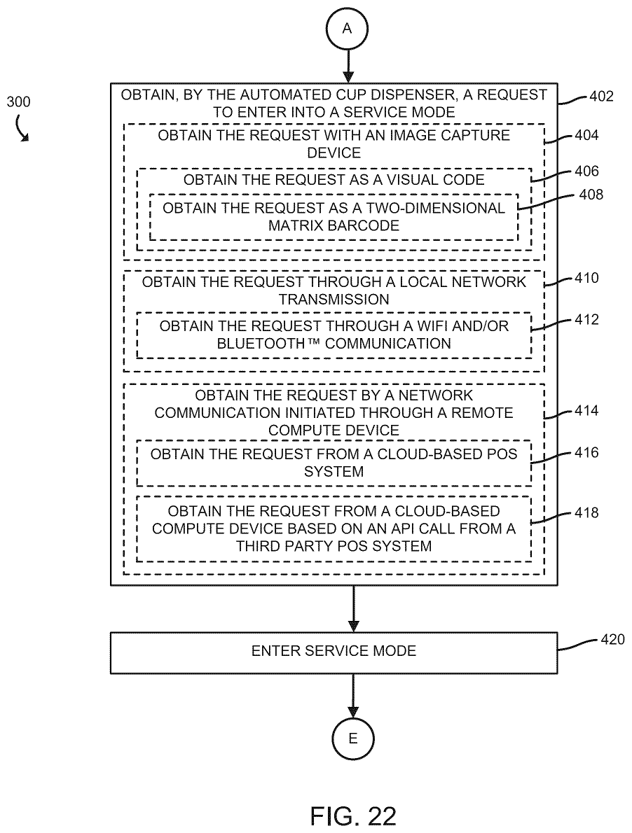

Referring now to FIG. 21, the method begins with block 400 in which a determination is made whether a request is received to enter a service mode. If the service mode request is received, the method advances to block 402 (FIG. 22) in which the automated cup dispenser 100 obtains a request to enter into a service mode. The request to enter service mode could be made in a variety of ways. For example, the automated cup dispenser 100 may obtain the request with an image capture device 226 (e.g., a camera or barcode scanner), as indicated by block 404. For example, and as indicated in block 406, the automated cup dispenser 100 may obtain the notification as a visual code. The visual code may be a two-dimensional barcode (e.g., a quick response (QR) code or barcode), as indicated in block 408. In other embodiments, the visual code may be embodied as a one dimensional bar code, or other set of symbols or shapes. For example, a manager or other employee at the merchant location 106 could be provided a service code in the form of a special QR code or barcode that causes the automated cup dispenser 100 to enter into the service mode. In some embodiments, the automated cup dispenser may obtain the request to enter the service mode through a notification made on a local network, as indicated in block 410. For example, and as indicated in block 412, the dispenser 100 may obtain the notification through a local WiFi or Bluetooth™ communication. In some cases, the automated cup dispenser may obtain the request to enter the service mode through a notification made by a remote compute device, as indicated in block 414. For example, and as indicated in block 416, the dispenser 100 may obtain the notification from a cloud-based POS system. In some cases, as indicated by block 418, the dispenser 100 may obtain the notification through an API call from a third party POS system. Regardless of the manner by which the request to enter into the service mode is received, the method proceeds to block 420 in which the dispenser 100 enters into service mode.

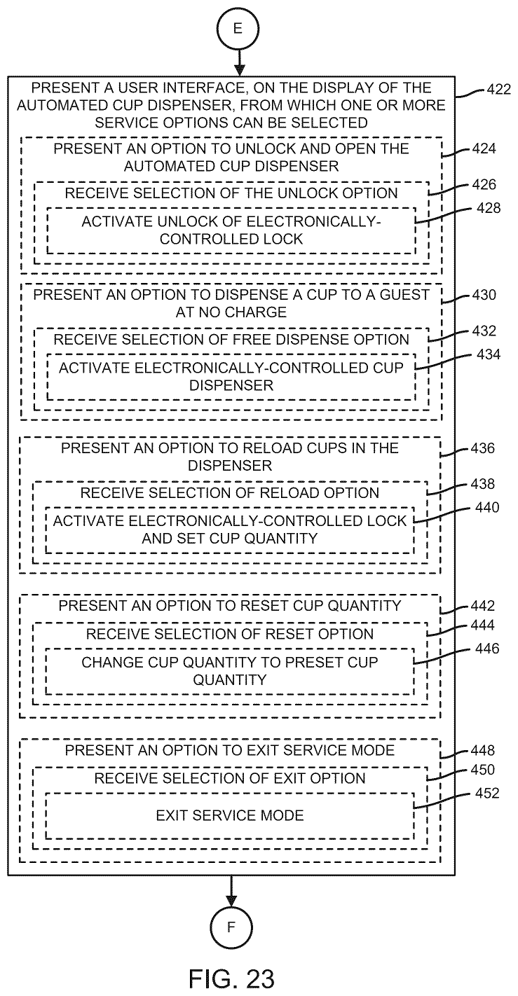

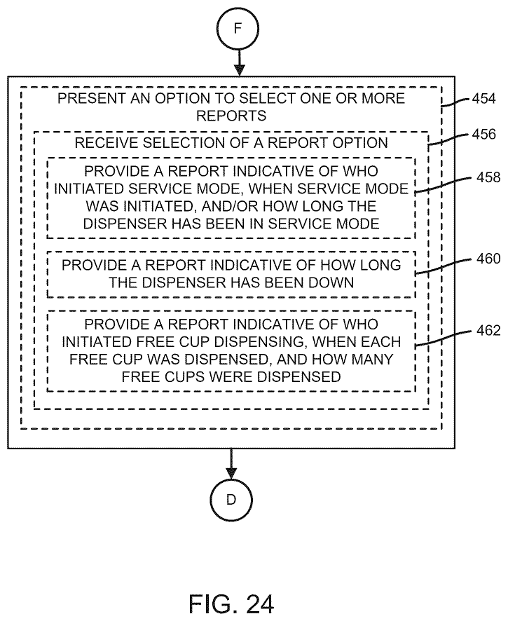

Referring now to FIG. 23, the method proceeds to block 422 in which the automated cup dispenser 100 presents a user interface with one or more service options that can be selected. For example, as indicated by block 424, the dispenser 100 may present an option to unlock and open the automated cup dispenser 100. As discussed herein, the dispenser 100 may include an electronically-controlled lock 228 and selecting this option (block 426), could activate unlocking the electronically-controlled lock (block 428), which allows an access panel or door to be opened so internals of the dispenser can be servicing and/or cups refilled. In some cases, as indicated in block 430, the user interface would present an option to dispense a cup to a guest at no charge. Upon receiving selection of this option (block 432), the dispenser 100 will activate the electronically-controlled cup dispenser to dispense a cup, as indicated by block 434. Depending on the circumstances, the user interface could present an option to reload cups in the dispenser 100 (block 436). Upon selection of this option (block 438), the dispenser 100 would activate the electronically-controlled lock 228 so an access panel or door can be opened to reload the cups in the dispenser 100, as indicated by block 440. In the embodiment shown, the user interface may present an option to reset the cup quantity in the dispenser 100 (block 442). Upon selection of that option (block 444), the dispenser 100 will change the cup quantity to a pre-determined amount, as indicated in block 446. In some cases, the user interface may present an option to exit service mode (block 448), and upon selection (block 450), the dispenser 100 will exit service mode (block 452). In some embodiments, as shown in FIG. 24, there could be an option presented on the user interface to select one or more reports (block 454). Upon receiving selection of that option (block 456), the dispenser 100 could present one or more reports, such as a report indicating who initiated service mode, when service mode was initiated, and/or how long the dispenser 100 has been in service mode (block 458), a report indicating how long the dispenser has been down (block 460), and/or a report indicating who initiated free cup dispensing, when each free cup was dispensed, and how many free cups were dispensed (block 462). In some cases, the dispenser 100 could send one or more reports on a periodic basis to the POS system 106.

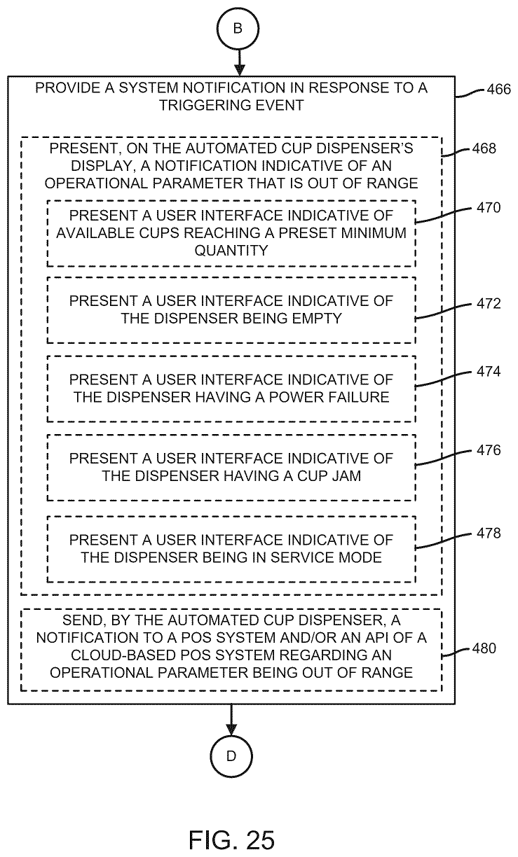

Referring back again to FIG. 21, the method proceeds to block 464 in which a determination is made whether a system notification has been triggered. If a system notification is triggered, and referring to FIG. 25, the method proceeds to block 466 in which the dispenser 100 provides a system notification in response to a triggering event. In some cases, the dispenser 100 presents a notification on the display 224 regarding an operational parameter of the dispenser 100 that is out of range (block 468). For example, the dispenser 100 could present a notification on a user interface indicative of available cups reaching a preset minimum quantity, as indicated by block 470. In some cases, the user interface could include a notification regarding the dispenser 100 being empty (block 472). In some embodiments, the dispenser 100 could include a notification indicating the dispenser 100 has had a power failure, as indicated in block 474. The system notification could indicate that the dispenser is having a cup jam, as indicated by block 476. In some cases, the user interface could present a system notification that the dispenser 100 is in service mode, as indicated by block 478. Depending on the circumstances, instead of or in addition to the user interface on the display, the dispenser 100 may send the system notification to a POS system and/or an API of a cloud-based POS system regarding an operational parameter being out of range, as indicated by block 480.

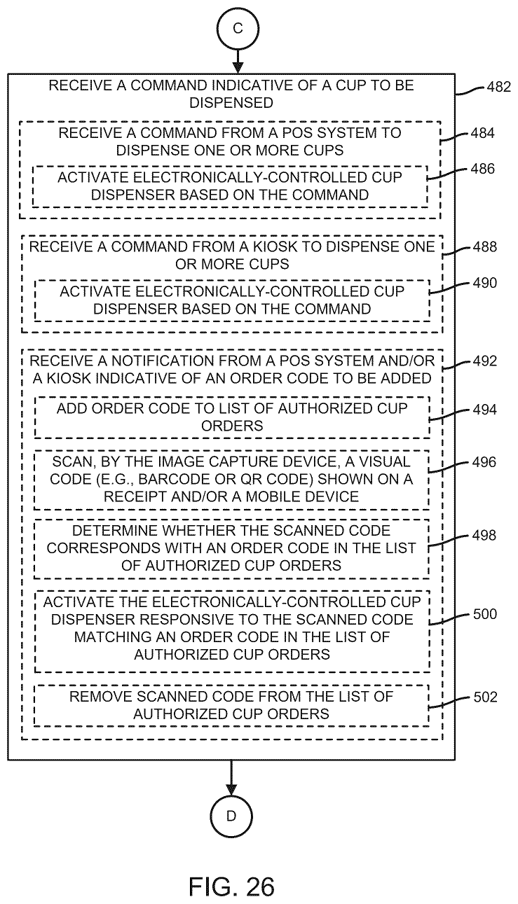

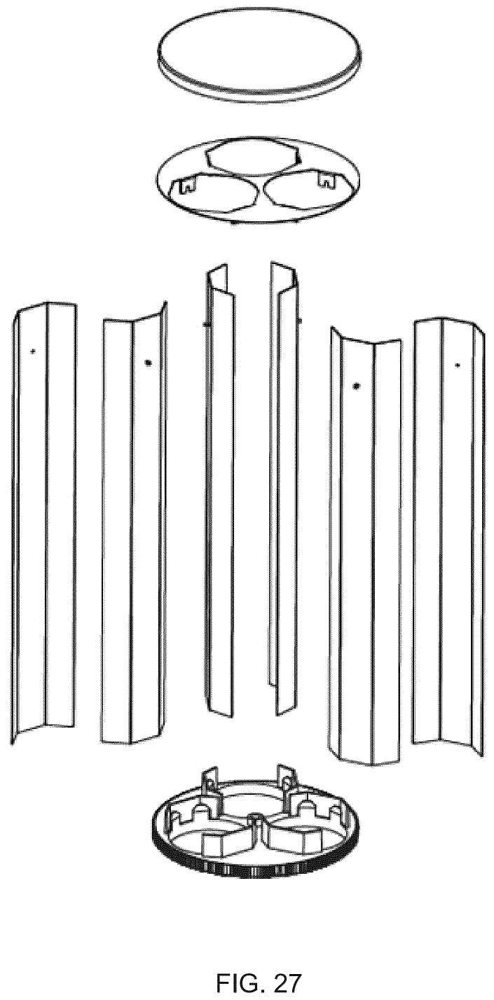

Referring again to FIG. 21, if no system notification has been triggered, the method proceeds to block 482 (FIG. 26) in which the dispenser 100 receives a command indicating a cup needs to be dispensed. As discussed herein, there may be multiple ways that the dispenser 100 dispenses a cup. In the embodiment shown, the dispenser 100 may receive a command from a POS system to dispense one or more cups (block 484), and in response will activate the electronically-controlled cup dispenser 230 to dispense one or more cups based on the command, as indicated by block 486. In some cases, the dispenser 100 may receive a command from a kiosk to dispense one or more cups (block 488), and in response will activate the electronically-controlled cup dispenser 230 to dispense one or more cups based on the command, as indicated by block 490. In some embodiments, the dispenser may receive a notification from a POS system and/or kiosk indicating that an order needs to be added (block 492). In response to receiving the notification, the dispenser 100 may add an order code to a list of authorized cup orders (block 494). Then, when a guest scans a visual code with the image capture device 226 (block 496), the dispenser 100 will determine whether the scanned code corresponds with an order code in the list of authorized orders, as indicated by block 498. In response to the scanned code matching an order code in the list of authorized cup orders, the dispenser 100 will activate the electronically-controlled cup dispenser 230 as indicated in block 500. Upon dispensing the cup, the dispenser will remove the scanned code from the list of authorized cup orders (block 502).

Though the operations of the methods shown in FIGS. 21-26 are described in a particular sequence, it should be understood that in other embodiments, operations may be performed in a different order and/or in parallel. While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes an automated cup dispenser with a dispenser body having an internal passageway dimensioned to hold a stack of cups and an electronically-controlled cup dispenser configured to selectively release a bottom cup from the stack of cups. The automated cup dispenser includes circuitry configured to: receive a command indicative of one or more cups to be dispensed; and activate the electronically-controlled cup dispenser in response to receiving the command to dispense one or more cups based on the command.

Example 2 includes the subject matter of Example 1, and wherein the command is received from a POS system, and the circuitry is configured to activate the electronically-controlled cup dispenser in response to receiving the command from the POS system.

Example 3 includes the subject matter of Examples 1-2, and wherein the command is received from a kiosk, and the circuitry is configured to activate the electronically-controlled cup dispenser in response to receiving the command from the kiosk.

Example 4 includes the subject matter of Examples 1-3, and wherein the command comprises a notification from a POS system indicative of an order code to be added to a list of authorized cup orders.

Example 5 includes the subject matter of Examples 1-4, and further comprising an image capture device, and the circuitry is configured to determine whether a visual code scanned by image capture device matches an order code in the list of authorized cup orders.

Example 6 includes the subject matter of Examples 1-5, and wherein circuitry is configured to activate the electronically-controlled cup dispenser response to the visual code scanned by the image capture device matches the order code.

Example 7 includes the subject matter of Examples 1-6, and wherein the circuitry is configured to remove the order code corresponding to the visual code from the list of authorized cup orders.

Example 8 includes the subject matter of Examples 1-7, and wherein the visual code is one or more of a barcode and/or a QR code.

Example 9 includes the subject matter of Examples 1-8, and wherein the circuitry is configured to receive a request to enter a service mode.

Example 10 includes the subject matter of Examples 1-9, and wherein the circuitry is configured to receive the request to enter the service mode by capturing a visual code indicating the service mode should be entered by the image capture device.

Example 11 includes the subject matter of Examples 1-10, and wherein the visual code to enter the service mode comprises one or more of a barcode and/or a QR code.

Example 12 includes the subject matter of Examples 1-11, and wherein the circuitry is configured to receive the request to enter the service mode by a local network transmission.

Example 13 includes the subject matter of Examples 1-12, and wherein the local network transmission comprises a wireless communication.

Example 14 includes the subject matter of Examples 1-13, and wherein the circuitry is configured to receive the request to enter the service mode by a network communication from a remote compute device.

Example 15 includes the subject matter of Examples 1-14, and wherein the network communication from the remote compute device comprises a request from a cloud-based POS system and/or a call to an API of a POS system.

Example 16 includes a method comprising the steps of: receiving, by an automated cup dispenser, a command indicative of one or more cups to be dispensed; and activating, by the automated cup dispenser, an electronically-controlled cup dispenser in response to receiving the command to dispense one or more cups based on the command.

Example 17 includes the subject matter of Example 16, and wherein the command is received from a POS system, and the an automated cup dispenser is configured to activate the electronically-controlled cup dispenser in response to receiving the command from the POS system.

Example 18 includes the subject matter of Examples 16-17, and wherein the command is received from a kiosk, and the an automated cup dispenser is configured to activate the electronically-controlled cup dispenser in response to receiving the command from the kiosk.

Example 19 includes the subject matter of Examples 16-18, and wherein the command comprises a notification from a POS system indicative of an order code to be added to a list of authorized cup orders.

Example 20 includes the subject matter of Examples 16-19, and further comprising an image capture device, and the an automated cup dispenser is configured to determine whether a visual code scanned by image capture device matches an order code in the list of authorized cup orders.

Example 21 includes the subject matter of Examples 16-20, and wherein the automated cup dispenser is configured to activate the electronically-controlled cup dispenser in response to the visual code scanned by the image capture device matches the order code.

Example 22 includes the subject matter of Examples 16-21, and wherein the automated cup dispenser is configured to remove the order code corresponding to the visual code from the list of authorized cup orders.

Example 23 includes the subject matter of Examples 16-22, and wherein the visual code is one or more of a barcode and/or a QR code.

Example 24 includes the subject matter of Examples 16-23, and wherein the automated cup dispenser is configured to receive a request to enter a service mode.

Example 25 includes the subject matter of Examples 16-24, and wherein the automated cup dispenser is configured to receive the request to enter the service mode by capturing a visual code indicating the service mode should be entered by the image capture device.

Example 26 includes the subject matter of Examples 16-25, and wherein the visual code to enter the service mode comprises one or more of a barcode and/or a QR code.

Example 27 includes the subject matter of Examples 16-26, and wherein the automated cup dispenser is configured to receive the request to enter the service mode by a local network transmission.

Example 28 includes the subject matter of Examples 16-27, and wherein the local network transmission comprises a wireless communication.

Example 29 includes the subject matter of Examples 16-28, and wherein the automated cup dispenser is configured to receive the request to enter the service mode by a network communication from a remote compute device.

Example 30 includes the subject matter of Examples 16-29, and wherein the network communication from the remote compute device comprises a request from a cloud-based POS system and/or a call to an API of a POS system.

1. An automated cup dispenser comprising:
a dispenser body with an internal passageway dimensioned to hold a stack of cups;
an electronically-controlled cup dispenser configured to selectively release a bottom cup from the stack of cups;
circuitry configured to:
receive a command indicative of one or more cups to be dispensed; and
activate the electronically-controlled cup dispenser in response to receiving the command to dispense one or more cups based on the command.

2. The automated cup dispenser of claim 1, wherein the command is received from a POS system, and the circuitry is configured to activate the electronically-controlled cup dispenser in response to receiving the command from the POS system.

3. The automated cup dispenser of claim 1, wherein the command is received from a kiosk, and the circuitry is configured to activate the electronically-controlled cup dispenser in response to receiving the command from the kiosk.

4. The automated cup dispenser of claim 1, wherein the command comprises a notification from a POS system indicative of an order code to be added to a list of authorized cup orders.

5. The automated cup dispenser of claim 4, further comprising an image capture device, and the circuitry is configured to determine whether a visual code scanned by image capture device matches an order code in the list of authorized cup orders.

6. The automated cup dispenser of claim 5, wherein the circuitry is configured to activate the electronically-controlled cup dispenser response to the visual code scanned by the image capture device matches the order code.

7. The automated cup dispenser of claim 6, wherein the circuitry is configured to remove the order code corresponding to the visual code from the list of authorized cup orders.

8. The automated cup dispenser of claim 6, wherein the visual code is one or more of a barcode and/or a QR code.

9. The automated cup dispenser of claim 5, wherein the circuitry is configured to receive a request to enter a service mode.

10. The automated cup dispenser of claim 9, wherein the circuitry is configured to receive the request to enter the service mode by capturing a visual code indicating the service mode should be entered by the image capture device.

11. The automated cup dispenser of claim 10, wherein the visual code to enter the service mode comprises one or more of a barcode and/or a QR code.

12. The automated cup dispenser of claim 9, wherein the circuitry is configured to receive the request to enter the service mode by a local network transmission.

13. The automated cup dispenser of claim 12, wherein the local network transmission comprises a wireless communication.

14. The automated cup dispenser of claim 9, wherein the circuitry is configured to receive the request to enter the service mode by a network communication from a remote compute device.

15. The automated cup dispenser of claim 14, wherein the network communication from the remote compute device comprises a request from a cloud-based POS system and/or a call to an API of a POS system.

16. A method comprising:
receiving, by an automated cup dispenser, a command indicative of one or more cups to be dispensed; and
activating, by the automated cup dispenser, an electronically-controlled cup dispenser in response to receiving the command to dispense one or more cups based on the command.

17. The method of claim 16, wherein the command is received from a POS system, and the automated cup dispenser is configured to activate the electronically-controlled cup dispenser in response to receiving the command from the POS system.

18. The method of claim 16, wherein the command is received from a kiosk, and the automated cup dispenser is configured to activate the electronically-controlled cup dispenser in response to receiving the command from the kiosk.

19. The method of claim 16, wherein the command comprises a notification from a POS system indicative of an order code to be added to a list of authorized cup orders.

20. The method of claim 19, further comprising an image capture device, and the automated cup dispenser is configured to determine whether a visual code scanned by image capture device matches an order code in the list of authorized cup orders.
